(19) United States
(12) Patent Application Publication
(10) Pub. No.: US 2015/0293988 A1
(43) Pub. Date: Oct. 15, 2015

(54) System and Method for Opinion Sharing and Recommending Social Connections

(71) Applicant: Jeremiah D. Eubanks, Fort Worth, TX (US)

(72) Inventor: Jeremiah D. Eubanks, Fort Worth, TX (US)

(21) Appl. No.: 14/249,634

(22) Filed: Apr. 10, 2014

(51) Int. Cl. G06F 17/30; H04L 29/06; H04L 29/08

(52) U.S. Cl. CPC G06F 17/30598; H04L 67/306; G06F 17/30867; H04L 65/403

(57) ABSTRACT

System for determining relationship compatibility for plural users within a network. User accounts are established in a database for plural users, who input questions, which are classified by topics. Responses are solicited from other users, which are stored in the database. A processor then determines opinions on the topics held by the plural users, either positive or negative, and stores them in the database. A first user then requests relationship recommendations, and the processor determines relationship compatibility factors for plural candidate users by sequentially correlating opinions of the plural candidate users with the opinions of the first user, and then recommends a subset of the plural candidate users for a relationship connection with the first user according to the relationship compatibility factors.

### BACKGROUND OF THE INVENTION

1. Field of the Invention

The present invention relates to social networking with opinion polling. More particularly, the present invention relates to on-line question and response opinion sharing service that extracts response information to predict compatibility for recommending social relationships.

2. Description of the Related Art

Social networking and relationship matchmaking websites are known, which incorporate a user profile that is completed by users of such systems. This data is used for review and comparison with other users in an effort to match users for a social relationship. This approach tends to be one-dimensional in that users input information with the understanding that it will be used to determined potential relationships. Some users take advantage of this arrangement to enhance their social appeal. Thus, there can be disappointment in the social connections that such systems recommend. There is also an aspect of privacy concerns, where certain users may be reluctant to input user profile information they deem too personal to share, yet which might be very useful information when utilized from social connection recommendation purposes.

Another aspect of on-line service and user participation is the gathering of information in a question and answer format. For example, opinions on political, religious, consumer, and other aspects of life are gathered through various Internet websites. Since many of these question and answer services allow users to respond anonymously, or with very little disclosure of personal information, users are typically more forthcoming with their personal feelings and beliefs on the subjects under discussion, which at times are rather controversial and private in nature.

Thus it can be appreciated that it would useful and advantageous to provide social networking services that gathered information in a manner that was private for users and encouraged open and honest disclosure from users, yet still maintained a sufficiently complete user profile so as to facilitate reliable recommendations for social connections, whether they might be romantic, plutonic, interest-based, or business-oriented connections.

### SUMMARY OF THE INVENTION

The need in the art is addressed by the methods and systems of the present invention. The present disclosure teaches a system and method of determining relationship compatibility amongst plural users, which operates within a network interconnecting a processor, a database, and plural network terminals. The system and method operate by establishing user accounts in the database for plural users, inputting questions into the database through the plural network terminals by the plural users, and classifying the questions according to plural topics. Then, soliciting responses to the questions from the plural users, which are then stored in the database. The processor determines opinions on the topics held by the plural users, either positive or negative, and stores them in the database, respectively, for the plural users. A first user requests relationship recommendations through a first network terminal, and the processor determines relationship compatibility factors for plural candidate users by sequentially correlating opinions of the plural candidate users with the opinions of the first user, and then recommends a subset of the plural candidate users for a relationship connection with the first user according to the relationship compatibility factors.

In a specific embodiment, the user accounts include facts and interests about corresponding users, which are entered by the corresponding users. In another embodiment, establishment of accounts further includes specifying plural subjects of interest for the plural users, which are selected from a predetermined list of interest subjects.

In a specific embodiment, questions are input together with specific selection criteria for a target audience within the plural users for whom a present question is directed. In another embodiment, a question format is selected from amongst a poll format, a short answer format, and a free-form text entry format.

In a specific embodiment, question topics are classified by comparing the words in a given question with a predetermined list of question topic words, thereby identifying a specific topic for the given question. In a refinement to this embodiment, the predetermined list of topic words is arranged in a hierarchal structure that defines taxonomy of topics. In another refinement, the words in a given question are compared with a dictionary or thesaurus to identify a closest matching word in the predetermined list of question topic words.

In a specific embodiment, soliciting responses further includes presenting a given question to a subset of the plural users who have a preexisting relationship with a first user who asked the given question. In another specific embodiment, soliciting responses further includes presenting a subset of recently asked questions from amongst the plural questions to the plural users.

In a specific embodiment, soliciting responses further includes presenting a given question to a given user because the topic of the given question correlates to the given user's account information, which may be interests, topics, or opinions, for example. In another specific embodiment, soliciting responses further includes presenting a given question to a subset of the plural users based on the frequency with which the given question has been previously responded to.

In a specific embodiment, determining opinions on topics further includes examining the words in the responses for positive and negative connotations. In another specific embodiment, determining opinions on topics further includes conducting a dictionary look-up of words in the response for predetermined positive and negative connotations, and translating the connotations into the positive and negative opinions.

In a specific embodiment, determining opinions on topics further includes making an inference determination on the words in the responses based on predetermined connotations of the words in the responses. In another specific embodiment, determining opinions on topics further includes examining a given user's account data for interest in a subject, and thereby inferring an interest in a corresponding topic.

In a specific embodiment, requesting relationship recommendations further includes specifying selection criteria to define a subset of the plural users eligible for a relationship recommendation. In a refinement to this embodiment, the selection criteria are selected from user gender, user interests, user facts, and/or user opinions.

In a specific embodiment, determining relationship compatibility factors further includes determining that a given user and a candidate user have both responded to a common question in the same way. In another specific embodiment, determining relationship compatibility factors further includes determining that a given user and a candidate user have both affirmed, or disaffirmed, the response of another user in the same way.

In a specific embodiment, determining relationship compatibility factors further includes comparing the facts and interests of the first user and the candidate users. In a refinement to this embodiment, determining relationship compatibility factors further includes individually weighting the comparison of facts, interests, and opinions in calculating the relationship compatibility factor.

In a specific embodiment, determining relationship compatibility factors further includes assessing the occurrence of common items in the user account database of the first user and each candidate user, thereby defining a commonality factor. In another specific embodiment, determining relationship compatibility factors further includes assessing the number of interactions on a given topic for the first user and each candidate user, thereby defining an importance factor.

### BRIEF DESCRIPTION OF THE DRAWINGS

FIG. 1 is a system and method overview flow chart according to an illustrative embodiment of the present invention.

FIG. 2 is a system functional block diagram according to an illustrative embodiment of the present invention.

FIG. 3 is a flow chart of the question entry and topic selection processes according to an illustrative embodiment of the present invention.

FIG. 4 is a flow chart of the question responses and comments processes according to an illustrative embodiment of the present invention.

FIG. 5 is flow chart of the relationship recommendation and meeting processes a according to an illustrative embodiment of the present invention.

FIG. 6 is a flow chart of the compatibility calculation process according to an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope hereof, and additional fields in which the present invention would be of significant utility.

In considering the detailed embodiments of the present invention, it will be observed that the present invention resides primarily in combinations of steps to accomplish various methods or components to form various apparatus and systems. Accordingly, the apparatus and system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the disclosures contained herein.

In this disclosure, relational terms such as first and second, top and bottom, upper and lower, and the like may be used solely to distinguish one entity or action from another entity or action without necessarily requiring or implying an actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

The illustrative embodiments of the present disclosure operate through an Internet server that has computer processing capability and access to database storage of system information, which includes user account information, question and response information, opinion determination information, social compatibility information, and other reference information and resources. The server functionality also includes a suite of access control and personal information security features. The service is thus hosted at one or more Internet protocol addresses, that are mapped through Uniform Resource Locators, as are known in the art. One embodiment uses the URL “AnOpinion.net”. Thus, users access the service through the URL, and each user's access device becomes a terminal on the network to access the host website as well as the processing and database functionality of the systems and methods of the present invention. The user terminal devices may be all manner of personal computers and all manner of wireless network access devices. Essentially, any device with Internet connectivity and a user interface can function as a network terminal device in the present invention.

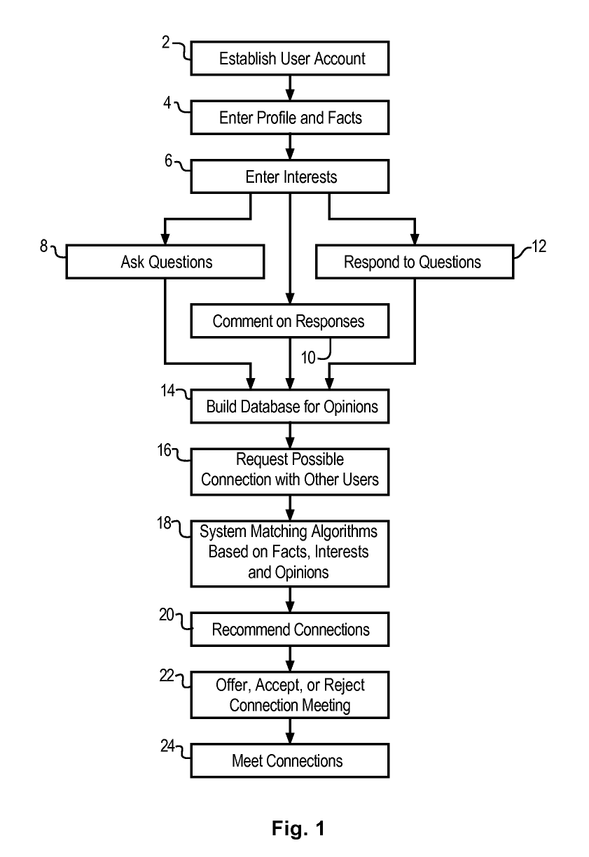

Reference is directed to FIG. 1, which is a system and method overview flow chart according to an illustrative embodiment of the present invention. This presents a broad overview of an illustrative embodiment. Further details and refinements of the system will be presented hereinafter. At step 2 in FIG. 1, a user account is established for one of the plural uses of the system. Typical user identification, contact, and credit information is required to establish an account and for the provision of secure access into the system. The user enters a predetermined set of profile information at step 4, and also other pertinent facts about themselves. Note that this information is not made public. The facts that are entered are useful in determining opinions and making social connection recommendations. At step 6, the user enters a selection of interests that they have, which are selected from a predetermined list of words. The list can be altered, however, the selection of interests are from the list. This approach insures that all interests are specified using predictable terminology that can be readily compared with other users in the comparison and connection determinations made by the system. Once the user has created an account and entered the requisite profile, facts and interests, they can proceed with participation in the activities and services of the system.

After step 6 in FIG. 1, the user can select another function within the system, and these options comprise asking a question of others (step 8), commenting on the prior responses of others (step 10), which is also referred to as a “nod”, or responding to questions others have asked (step 12). All of these activities feed information into both a user database of information and a question and response database, both of which contribute to building an overall database of information (step 14) from which user opinions can be inferred or otherwise determined. There are several complex operations used to deduce opinions, and opinions are a primary source of information used to determine whether one user is compatible with another user for a social or business relationship. A hierarchy of importance of useful information for calculating social compatibility is opinions, followed by interests, followed by facts. Thus the inferences of user opinions carry more weight than the information they selected and entered at the time their account was established. Other hierarchies can also be employed.

At step 16 in FIG. 1, the user requests recommendations for a social connection with other users. Note that there are a variety of social connections, including romantic, plutonic, interest oriented, and business oriented. The user can enter certain qualifications for the kinds of connection and kinds of users they are seeking. At step 18, the system processor executes a compatibility-matching algorithm, which includes a number of operations based on opinions, interests, and facts about the requesting user as well as a sequence of candidate users. In addition, these algorithms conduct certain inference and opinion processing based on the collection of source information about the users being compared for compatibility. The compatibility algorithms produce a compatibility factor for each candidate user. At step 20, the system presents a subset of the candidate users, which have the higher compatibility factors, for the user to consider for requesting an actual connection. At step 22, the user selects users for a connection, and then sends a system message to request a meeting, which can be accepted or rejected by the candidate users. At step 24, the requesting user and candidate user may decide to have an actual meeting, which could occur through a system messaging function, via e-mail, a social networking service, or a personal meeting in a place of their choosing.

Note that users share their opinions through more than responding to questions. Their opinions are also determined by their act of indicating agreement or disagreement with answers and comments of other users (step 10, in FIG. 1). A user can also indicate that another user's answer and comment was profound enough to affect their opinion on a topic. Their opinion can be affected by being confirmed, swayed or changed. Each of these actions; agree, disagree, swayed me, changed me, and confirmed me, are collectively called “nods” in the system. A user can give nods to answers and comments on questions even if they are not in the intended audience. For instance, if user John asks a question to single fathers and user Jack, who is a single father, provides a response with a comment to this question, user Judy can indicate agreement with Jack's response even though she cannot answer John's question.

With respect to the establishment of an account on the system and setting up a user profile, users first access the website, provide e-mail, password, contact and financial information for establishing an account. They then process through a series of profile questions, which define facts and interests of the user. The user is guided through the process with a list of inquiries to which they may respond as completely as they desire. By way of example in the illustrative embodiment, these may comprise the following information.

TABLE 1

| | |
|---|---|
| Identity | E-mail, name, password, security Q&A, birth date, photo, |
| | etc. |
| Geography | Last three residence addresses. |
| Biology | Gender, heath, disease, etc |
| Ancestry | Race, nationality, parents, etc. |
| Affinity | Parents, childhood, relationships, children, etc. |
| Theology | Religion, beliefs, etc. |
| Education | Schools & universities attended, degrees, certifications, |
| | etc. |
| Economy | Occupation, income, spending, etc |
| Personality | Sexual orientation, politics, hobbies, interests |

Generally speaking, words used in this disclosure are applied according to their respective dictionary definitions. However, it us useful to consider specific words applied in describing certain components and functions of the illustrative embodiments, in order to clarify some word usage. The inventor also reserves the right to define words, as a lexicographer, where useful. With respect to the various database information contemplated herein, the following terms are applicable.

TABLE 2

| | |
|---|---|
| Account | A minimum set of data required to be input and indexed to a user data |
| | structure, which is sufficient to enable a user to access the system. |
| Attribute | User entered facts about the user and interests in subjects describing |
| | them, which is added to a profile. Generally selected from lists, but some |
| | freeform entry is employed. Inferences can be drawn from attributes. |
| Attribute | Attributes are categorized by the type of personal information they relate |
| Type | to in order to properly limit selection to realistic terms where appropriate |
| | and to remove ambiguity in repeat of terms, such as homonyms and |
| | words with multiple meanings. Examples include: ‘Gender’, ‘Interest’, ‘City |
| | of Residence’, ‘Hometown’. Many attribute types will restrict attribute |
| | selection to a predefined list of allowed terms, such as ‘Age’ being limited |
| | to a number between 13 and 120 or ‘Hometown’ being limited to a named |
| | geographic location. A few attribute types will allow users to add attributes |
| | to the list of allowed terms, such as ‘Interest’, or ‘Occupation’. |
| Audience | A subset of the world of users that are enabled to respond to a question, |
| | which is established by a set of criteria entered by a questioner. When a |
| | questioner inputs a question, they can optionally limit which users may |
| | become respondents by choosing users from their connections or by |
| | specifying an attribute or combination of attributes which a potential |
| | respondent must have selected in their facts or interests before being |
| | enabled to give a response. |
| Connect | An agreement between users to establish a database link in the system |
| | that groups them together, such as by “family”, “friends” and “colleagues”. |
| | Such groups typically share real names amongst themselves. |
| Connections | For a given user, the list of other users with which they have connected in |
| | a given group. Generally, a relationship with other users who a user |
| | personally knows and has chosen to connect with using the system. |
| | Identified in the system by real name. Facts about a user are never visible |
| | to the user's connections because facts are kept confidential. Privacy |
| | encourages honesty and maximum participation in providing facts, |
| | especially those which are considered embarrassing or taboo. Users can |
| | optionally assign connections into groups or categories such as ‘Family’, |
| | ‘Friends’, ‘Colleagues’, etc. |
| Fact | User input personal and demographic information added to a profile. |
| Inference | Attribute and opinion data added to a profile that is determined by a |
| | system calculus process. For example, a user that interacts with a given |
| | topic plural times is inferred to have and interest in that topic. |
| Interests | User input information to a profile that describes subjects, things and |
| | activities, which are of interest to them. |
| Meet | A system matching algorithm that compares a users' opinions, interests, |
| | and facts to rank compatibility for a real-world meeting or relationship. |
| | Uses system function that employs a compatibility algorithm that |
| | compares a user's facts, interests and opinions to the facts, interests and |
| | opinions of other users and provides a ranking of the potential |
| | compatibility in a real-world relationship. When calculating the ranking, |
| | opinions may carry more weight than interests which, in turn may carry |
| | more weight than facts. |
| Member | A user who is part of an organization. |
| Nod | An opinion based on the user's act of indicating agreement or |
| | disagreement with a response from other user. A user can also indicate |
| | that another user's response affected their opinion. Their opinion can be |
| | affected by being affirmed, swayed or changed. A user can give nods to |
| | responses even if they are not within the intended audience of a given |
| | question. |
| Opinion | A collection of inferences based on plural responses submitted by a user, |
| | organized on a per-topic basis, and indicating a positive or negative bias |
| | the user has on each topic. Opinions are indexed to the user's profile. |
| | Generally, a calculus of a user's favorable or unfavorable (positive and |
| | negative) view of a topic based on responses to questions. |
| Opinion | An algorithm that employs a dictionary and thesaurus to compare terms |
| Matching | used in user responses and nods to match different responses from |
| | various users. |
| Organization | A named group of users, which may be public or private. |
| Profile | A group of data in a data structure that is indexed to a user, which |
| | includes account data. |
| Question | Information submitted to the system by a user, as questioner, with an |
| | intent to elicit plural responses, and which is proffered to an audience of |
| | other users, who may elect to respond as respondents. Questions and |
| | responses are stored in a Question and Response data structure. |
| | Generally, text entries are used, however, various other media (text, |
| | images, video, audio, hyperlinks, etc) can be used. A Question is not |
| | limited to an interrogative sentence, but can also be input as a declarative |
| | sentence that states the Questioner's opinion and requests a response. |
| | Questioners may request responses to be in a variety of forms, such as |
| | short text, narrative answers or by limiting responses to a selection of |
| | media items or a reference to media items in the question. |
| Questioner | A user who inputs a question to the system. Also, an organization that a |
| | user inputs a question on behalf of. |
| Response | The information input by a respondent as a response to a question. This |
| | can include the selection of an option in a poll format question, a textural |
| | entry to a question, or an agreement or disagreement ‘nod’ respecting |
| | another respondent's response to a question. |
| Respondent | A user that responds to a question. |
| Society | For a given user, all of the other users with which they have connected. |
| | The entire collection of a user's connections. |
| System | The claimed invention in combination with processing hardware, user |
| | network terminals and a network. |
| Topic | A category of questions that are associated in the question and answer |
| | data structure by a system process because they share objectively similar |
| | subject matter, which may be correlated by use of synonyms. Note that |
| | repeated interaction with a given topic by a user can generate an |
| | inference of interest for that user. A topic is also category name used to |
| | identify and group questions with similar objectives, objects, subjects or |
| | decisions. Topics are used to deliver questions, advertisements, and |
| | other content of a meaningful nature to users. Words used for topics |
| | names can be identical or synonymous with words used for interests. |
| User | An individual with an account on the system. |
| World | All of the users and organizations in the system. |

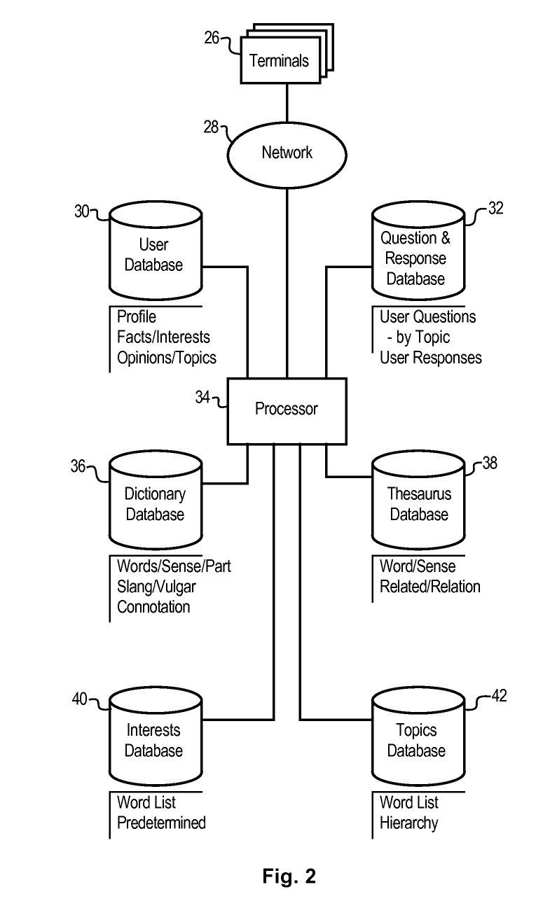

Reference is directed to FIG. 2, which is a system functional block diagram according to an illustrative embodiment of the present invention. The systems and methods of the present disclosure are hosted by a network 28, which is the Internet in the illustrative embodiment. Users access the system through plural network terminals 26, as was discussed hereinbefore. A measure of processing capability 34 is employed, which can exist in physical servers or commercial processing resources, as are known to those skilled in the art. Likewise, the various database and storage equipment can be source through physical servers or commercial resources. The system employs two primary database resources, a user database 30 and a question and answer database 32. The user database primarily contains the user account and profile information, including the facts, interest, opinions and topics that are pertinent to the plural users, respectively. The question and response database 32 comprises the user question, topic specification, and user responses, as well as user specified audience definition and certain other control information.

The system of FIG. 2 also employs a dictionary database 36 and a thesaurus database 38, both of which may be based on commercially available product resources, but may also include system specific data fields and information. The dictionary database 36 includes all the words and definitions, or course, but also comprises a “sense” field indicating which definition is appropriate, a “part” field indicating the part of speech (noun, verb, etc.), and an indicator as to whether the word is used in slang or has a vulgar meaning. In addition, there is a “connotation” field, which indicates whether the word is predetermined to have a negative or positive connotation when used to describe an interest or topics. The thesaurus database 38 can also be based on a commercial resource, but with added fields as well. For example, the “related” field indicates a sense of the words use, and the “relationship” field indicates relationship with the references word, such as a synonym or classification of topic, for example.

FIG. 2 also illustrates both an interest database 40 and a topic database 42. The interests database list all of the words and phrases that are allowed for use in defining an interest of a user. The topics database list a taxonomy of words that define topics for which questions may be asked and opinions may be proffered. The topics database 40 is generally more fluid than the interests database 42. Also, note that while the database arrangement is presented with divisions and structure to aid in describing and understanding the illustrative embodiments, the actual database structure may be considerably different. For example, it would be possible to store all of the data in a single data structure.

The dictionary database, item 36 in FIG. 2, comprises a listing of words with definitions, as would be expected. However, since the dictionary resource is applied for novel functions of the present invention, there are additional features. Words are stored in the dictionary database table, along with properties useful to the system or common to a dictionary such as part-of-speech, whether it is slang or vulgar, and connotation. Words are not limited to the English language. They can be in any language. Since many words have multiple meanings, they are differentiated using a “Sense” filed, which provides a more specific word to clarify the intended meaning. Part of speech is also used to differentiate the use and meaning of words in the system. The database of words is based on Webster's dictionary, but it is structured to grow to contain any other symbol or group of symbols, which are able to be input to a network terminal by a user, including phrases, acronyms, compound words, emoticons, and so forth. When a user inputs a word that does not exist in the dictionary database, it can be added. The following table presents a number of exemplary entries to assist in understanding the range of information and applications that can be supported.

TABLE 3

| Word | Root | Sense | Part | Slang | Vulgar | Connotation | Language |
|---|---|---|---|---|---|---|---|
| Home | | Residence | Noun | No | No | | English |
| Home | | Home | Noun | No | No | | English |
| | | Plate | | | | | |
| Schooling | School | Educate | Verb | No | No | | English |
| School | | | Noun | No | | | English |
| School | | Educate | Verb | No | No | | English |
| Home | | | Noun | No | No | | English |
| School | | | | | | | |
| Homeschool | | | Verb | No | No | | English |
| Escuela | | | Noun | No | No | | Spanish |
| Casa | | | Noun | No | No | | Spanish |
| Hate | | | Verb | No | No | Negative | English |
| Despise | | | Verb | No | No | Negative | English |
| Love | | | Verb | No | No | Positive | English |
| [symbol] | | | | | | Positive | |
| Van Halen | | | Proper | No | No | | |
| North Korea | | | Proper | No | No | | |
| Rangers | | Texas | Proper | No | No | | |
| | | Rangers | | | | | |
| | | Baseball | | | | | |
| | | Team | | | | | |
| Rangers | | New York | Proper | No | No | | |
| | | Rangers | | | | | |
| | | Hockey | | | | | |
| | | Team | | | | | |

The thesaurus database, item 38 in FIG. 2, comprises a listing of words with synonyms, as would be expected. However, since the thesaurus resource is applied for novel functions of the present invention, there are additional features. Stated more broadly, the thesaurus 38 is a database of words, which relate to each other. It can be used to identify topic classification, synonyms or even “translation” to an extent. Consider the example table below.

TABLE 4

| Word | Sense | Related | Relation |
|---|---|---|---|
| Home | Residence | Casa | Synonym |
| School | | Escuela | Synonym |
| Home School | | Homeschool | Synonym |
| Hate | | Despise | Synonym |
| [symbol] | | Happy | Synonym |
| [symbol] | | Smile | Synonym |
| Van Halen | | 80's Rock | Topic |
| DPRK | | North Korea | Synonym |
| DPRK | | Foreign Affairs | Topic |
| Home Plate | | Baseball | Topic |

The Interests Database 40 in FIG. 2 is a pre-populated list of words, but is can be amended to add additional words, including amendments by users of the system. Interests can also include proper nouns or acronyms, which represent real-world people, groups, or organizations, and, the system cannot predict or know all of these. Examples include; home school, Van Halen, North Korea, or ASPCA.

The Topics database 42 in FIG. 2 includes words as topics that are a limited, defined list of Words, which are hierarchically organized to create a taxonomy for Questions. Consider the following listing as an example of the topic taxonomy.
1) Relationships
   a) Parenting
      i) Home Schooling
   b) Marriage
   c) Dating
2) Culture & Entertainment
   a) Art
   b) Music
      i) 80's Rock
   c) Film
   d) Sports
      i) Baseball
3) Politics
   a) Economy
   b) Foreign Affairs
      i) North Korea
   c) Animal Rights
4) Health
5) Consumers

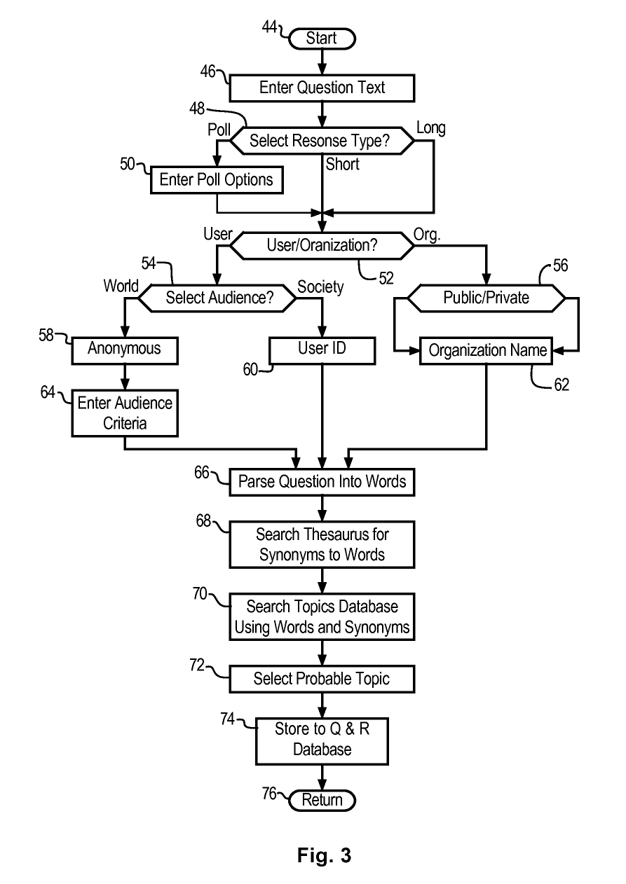

Reference is directed to FIG. 3, which is a flow chart of the question entry and topic selection processes according to an illustrative embodiment of the present invention. This illustrative embodiment begins at step 44 and proceeds to step 46 where a user of the system enters the text of a question. At step 48, the user then selects the type of response that will be accepted from amongst a poll format where responses are selected from the user's prepared list of options, or a short response format that accepts a limited character space of words, or a long response format where answers with longer character space is allowed. In another embodiment, the system advantageously utilizes a short responses make it easier to identify and compare opinions. If the poll format is specified at step 48, the process goes to step 50 where the user enters a selected listing of poll options. Next, at step 52, the user selects whether this question is being presented from the user himself, as a representative of an organization. This choice determines the nature of the audience that will be enabled to respond, and also the amount of information that is disclosed about the questioner.

If the user selects and organization at step 52 in FIG. 3, then the process goes to step 56 where the user selects between a public or private question, indicating whether it is presented solely within the organization, or to a greater audience in the world. At step 62, the system establishes that the questioner will be identified by the name of the organization with which the user is connected. The process then continues to step 66, which is described hereinafter.

On the other hand, at step 52, if the user selects “user” as the questioner, then the process goes to step 54 where the user specifies the intended audience for the present question, which can be either the entire world of users of the system, or a specified society to which the user is a member. If the user selects society, which is a group of connected users, then the system defaults to disclose the identity of the questioner when the question is presented to other members of his society at step 60. It should noted that the representation of identity is similar for both respondents as for questioners. If the questioner's true identity is disclosed, so will each respondents to the other respondents, but only to those in the included in a common society. If the Questioner is represented using an anonymous identity, so will each Respondent. On the other hand, at step 54, if the user selects the world has the audience for the present question, then the system sets the user identity to anonymous at step 58, and the user goes on to select the audience criteria at step 64. For example, the user might select men in the age range from 21-35 years, or people with an interest in golfing, or other interests. This causes the system to later solicit responses from users who fit the audience selection criteria. Regardless of the user, question, or audience criteria, the system then proceeds to correlate to topic to the present question, which begins at step 66.

At step 66 in FIG. 3, the system begins the topic determination process by parsing the user's question into individual words, for a word-by-word analysis process. At step 68, the system searches the thesaurus database from synonyms to the words, and at step 70 the system searches the topics database for matching topics using the words and synonyms at hand. At step 72 the system selects a most probably topic from the topics list, and at step 74 the question, the user specified criteria, and the topic are stored in the question and response database for presentation to other user to solicit responses. The process then returns at step 76. Also note that in other illustrative embodiments, the user may specify a topic from the topic database for a new question, which obviates the system's need to select a topic for that question.

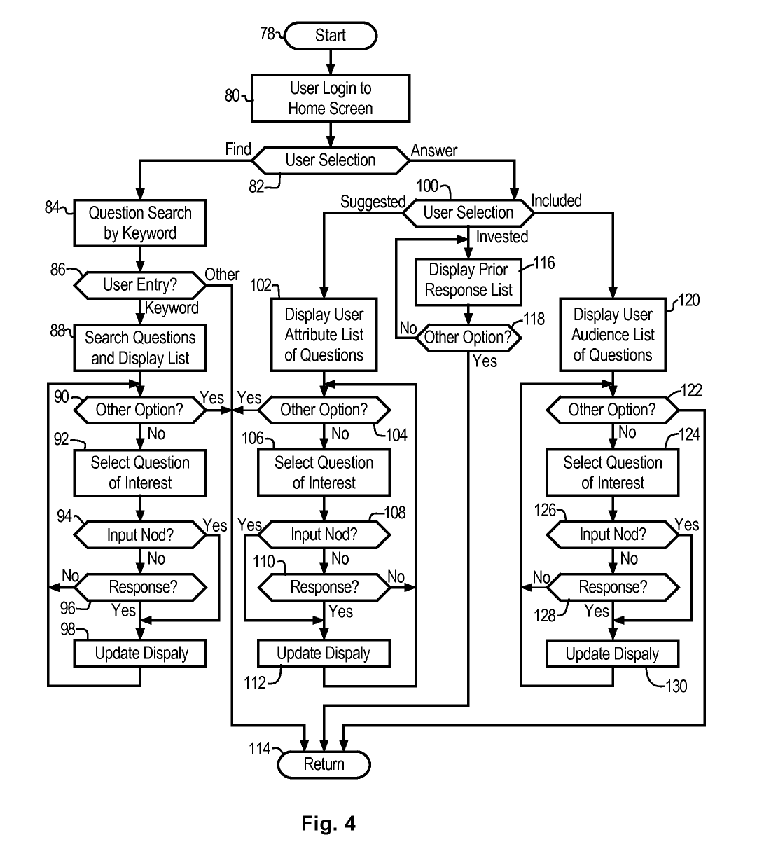

Reference is directed to FIG. 4, which is a flow chart of the question responses and comments processes according to an illustrative embodiment of the present invention. Having submitted a number of question into the question and response database, as discussed in regard to FIG. 3, FIG. 4 details the subsequent response entry processes. This begins at step 78 and proceeds to step 80 where a user logs into the system at a network terminal, which then directs the user to a home page display screen. The user then selects, at step 82, whether they desire to search for questions of interest they would like to respond to, or whether they would prefer to respond to questions that are offered to them by the system. Question can be offered from a number of reason, such as the user being within a target audience for the question, because a question has become popular, because the question is pertinent to an interest of the user, and for other reasons.

If the user selects the find questions to answer option at step 82 in FIG. 4, the process continues to step 84 where the user begins a question search by using keywords. At step 86, the system tests for a keyword input from the user. If a keyword is input, then the system proceeds to step 88 to continue the process. On the other hand, if the user has made some other selection from the homepage, then the process is exited and returns at step 114. At step 86, if the user entered “golf”, for example, then the system, at step 88, searches the question and response database using “golf” as a keyword, and the system presents a list of the most pertinent questions discovered in the question and response database. At step 90, the user may opt out of actually responding to a question and then process returns at step 114. If the user doesn't opt out at step 90, then the user selects a question of interest from the list at step 92. The user may simply decide to input a nod, either agreeing or disagreeing with an existing response, at step 94. If they input a nod, the display is updated with that response at step 98, and the process returns to step 90 where the user might select another question from the search list to respond to. If the user does not enter a nod at step 94, then they may elect to enter a respond at step 96. A response is the selection of a poll option or the entry of a response, depending on the format of the question at issue. If no response is entered at step 96, then the process returns to step 90 so the user may select another question. If a response is entered at step 96, then the display is updated at step 98 and the process returns to step 90 for another question selection.

Returning now to step 82 in FIG. 4, where the user has selected to answer a question that will be offered to them by the system, the process continues to step 100. At step 100, the user decides to view questions that are either suggested to them by the system, questions for which they are included in the target audience, or questions they are invested in by virtue of prior responses submitted by the user. These approaches to question recommendation serve to select and narrow the range of question offered so as to focus the process on areas most suitable for each given user. If the user selects suggested questions at step 100, the process continues to step 102 where the system searches and displays a listing of question that are prioritized according the a matching algorithm based on the user's attributes, include facts and interests. The user can opt out of responding at step 104, which returns the process at step 114. Otherwise, the user selects one of the offered questions at step 106. At step 108, the user can simply respond with a nod, after which the display is updated at step 112 and returns to step 104 to pass through the process loop again for more options. On the other hand, at step 108, the user may proceed to step 110 and enter a response to the selected question, and then the display is updated at step 112 and returns to step 104.

Returning to step 100 in FIG. 4, if the user selected to view questions they were previously invested in, the process continues to step 116. At step 116, the system displays a prior response list for the user to review and possible amend, in a fashion similar to that described with respect to the “suggested” option. If the user selects some other options at step 118, the process returns to step 114.

Returning now to step 100 in FIG. 4, where the user has selected to answer a question that will be offered to them by the system, the process continues to step 120, where the system searches and displays a listing of question that are included because the present user's attributes match the attributes specified by the original questioner. The user can opt out of responding at step 122, which returns the process at step 114. Otherwise, the user selects one of the offered questions at step 124. At step 126, the user can simply respond with a nod, after which the display is updated at step 130 and returns to step 122 to pass through the process loop again for more options. On the other hand, at step 126, the user may proceed to step 128 and enter a response to the selected question, and then the display is updated at step 130 and returns to step 122.

There are various techniques contemplated under the teachings of the present invention to match and offer questions to user manners that are efficient and interesting to the users. This is useful because it is the process of responding to questions that builds the question and answer database and enables the system to make inferences therefrom and to develop accurate opinions, both useful in making compatibility determinates and suggesting social and business meetings between users. The following outline format structures some of the techniques used to accomplish this under the teachings of the illustrative embodiments.

Response Processes:

1) How does user get/find questions to respond to?
a)—Alerted of new questions because of connection or affiliation with an organization.
b)—Review a list of most recent questions.
c)—Review a list of most frequently answered questions.
d)—Alerted of new questions, or search for questions from user connections.
e)—Search for topics by scanning a list of topics.
f)—Search for topics of interest using a character string search.
g)—Search by user interests.

2) How does user decide/control what is disclosed about himself as respondent?
a)—System default presets offering limited information.
b)—Select from a menu of standardized options.
c)—Custom design items from profile to disclose.
d)—Based on parameters of original question.

3) Enter responses to questions.
a)—Chose a question to respond to.
b)—Enter response according to format offered (i.e. poll, short answer, long answer).
c)—Store response to question and response database.
d)—Notify questioner that a response has been submitted (optional).

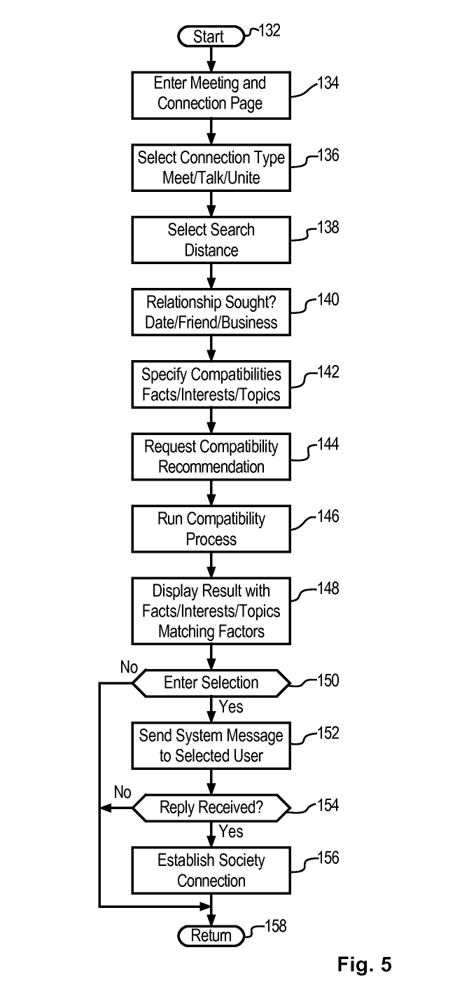

Reference is directed to FIG. 5, which is flow chart of the relationship recommendation and meeting processes according to an illustrative embodiment of the present invention. This presents a general outline of a meeting and connection process between users according to one illustrative embodiment. The process begins at step 132 and proceeds to step 134 where a requesting user enters a meeting and connection page on a network terminal, and proceeds to step 126, where the user selects the type of connection that is desired. The options can be to meet someone, talk with someone, or unite with someone. In other embodiments the options are to connect, which is the process that a users builds society connections with real-world relationships and group these people according to relationship. Another option is the meet users, which is to enter the matching program to request matches. Another options is to talk, which is a messaging system to carry on conversations with meet introductions, society connections, and possibly groups/others. Yet another option is to unite users, which is a method of building public groups where users with specific opinions and interests can join and participate in conversations, and share information related to their interests, causes, or goals. Continuing, at step 138, the user defines a geographic distance within which the system will search for other users for a connection. This serves to limit the number and users that will be compared, and also to locate users who are geographically relevant to the requesting user. At step 140, the user selects the type of relationship that is sought, from amongst a romantic date, a friend, and a business connection. At step 144, the requesting user requests that the system perform a compatibility search and proffer recommendations. At step 146, the system performs a substantive compatibility analysis process, which is detailed more completely hereinafter. At step 148, the system display the results of the compatibility process to the requesting user together with metrics on the matching factors for facts, interest, and opinions shared between the requesting user and the individual users that have been matched. At step 150, the user has the option to select one of the matched users for an actual introduction and meeting. If the user decides against an introduction, the process returns at step 158. If an introduction is requested at step 150, the system sends a system message to the selected matching user, and the requesting user awaits a response at step 154. If the matched user does not reply, the process returns at step 158. On the other hand, at step 154, if the matched user does respond, then the two users are free to establish a society connection or arrange a meeting off line in the real world. The process returns at step 158.

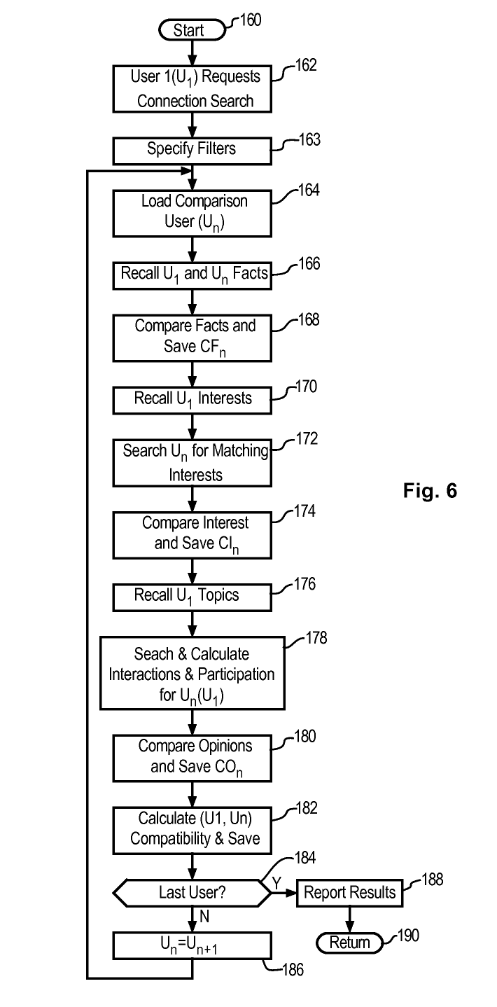

Reference is directed to FIG. 6, which is a flow chart of the compatibility calculation process according to an illustrative embodiment of the present invention. This is a generalized process according to one illustrative embodiment, and a more detailed process will be described hereinafter. In FIG. 6, the process begins at step 160 and proceeds to step 162 where a requesting user (U₁) requests a connection search be conducted by the system. At step 163, the requesting user may specify filters to limit the types of matching users that may be discovered. For example, users who are geographically close, or who share specific interests, or that share specific opinions, gender, age, and so forth. The system utilizes this information to sequence through plural candidate users in steps 164 through 186, testing plural candidate users (Uₙ).

At step 164, attributes of a first candidate user are loaded into the process from the user database. At step 166, the facts from both the requesting and candidate user are recalled, and then at step 168 they are compared and a facts comparison factor for the current candidate user is produced (CFₙ). At step 170, the interests from the requesting user are recalled and at step 172, the candidate user's interests are located. At step 174, the candidate user and requesting user interests are compared and an interests comparison factor for the current candidate user is produced (CIₙ). At step 176, the requesting user topics are recalled from the user database, and at step 178, the system searches for and calculates interaction and participation factors for the candidate user in view of the requesting user. This aspect of the process will be more fully described hereinafter.

At step 180, the opinions of the requesting user and the candidate user are compared and an opinion comparison factor (COₙ) is calculated and saved. At step 182, the system calculates a compatibility factor based on the facts, interests, and opinions comparison factors, and saves the compatibility factor for later results reporting. At step 184, the system tests to determine if this is the last candidate user. If note the process increments the candidate user index at step 186 and repeats the forgoing process for that user. If it is the last candidate user, the results are reported to the requesting user at step 188 and the process returns at step 190.

As will be noted from the foregoing discussion, there are two aspects of determining compatibility between two users in the illustrative embodiment. The first is inferring each user's opinions on topics based on prior responds and other attributes, and the second is determining a compatibility factor that is based on, at least in part, the opinion calculus. Thus, the opinion determination process is useful in the process of matching user based on compatibility. The following outline is instructive in the ways that opinions are determined in the illustrative embodiment.

Opinion Determination Process:
1)—Direct reading of response in the question and the response database made by a user, which are prima facie opinions about topics.
   a)—Opinions are correlated to topics.
   b)—Topics are discriminated and defined per the topics database, which is fixed, but can be augmented.
2)—Inferences calculus based on user responses in the question and response database based on words submitted in responses, which determines both an opinion on a topic or an interest in a subject.
   a)—Subjects and topics are both defined using words, and there is significant overlap.
   b)—Topics differ from subjects in that topics are hierarchal.
3)—Opinion matching, which is an algorithm that refers to a dictionary and thesaurus for comparing words used by a respondent in order to establish that user's opinion on a topic.
4)—Nods entered by a user expressing a positive or negative view of other user's responses.

The compatibility calculus and meeting processes are based on algorithms that draw from the foregoing opinion calculus, and optionally the user attributes, including facts and interests. There is also an influence based on the requesting user's selection criteria. The following terminology is useful in understanding the compatibility determination processes of the illustrative embodiment.

TABLE 5

| | |
|---|---|
| Compatibility | A numeric value (0 to 1) representing the likelihood |
| Factor | that two USERS could successfully form personal |
| | bonds and maintain a positive relationship. |
| Comparison | An algorithm that compares the similarity of two given |
| | lists of data and produces numeric result to represent |
| | their similarity. |
| Factor | A numeric value (0 to 1) mathematically combined with |
| | other numeric values in order to produce a result. |

The compatibility meeting portion of the system calculates compatibility between two users. One user is the requesting user (U₁), who seeks to meet other users with high compatibility. The following formulas are used to make this recommendation to the requesting user. Overall compatibility is represented by a numerical value ranging from 0 to 1, as a percentage. Other representations could also be employed. In the illustrative embodiment, the following formula is utilized.

Compatibility(U₁,Uₙ)=a/b;where a<=b Equation 1:

Compatibility calculations are made using a comparison of facts, interests, and opinions shared between the requesting user (U₁) and another candidate user (Uₙ). Each of the comparisons are given a predetermined weighting that provides a greater influence for opinions over interests, and greater weighting of interests over facts. Although other ratios and comparison schemes can also be employed. In the illustrative embodiment, facts are given a 2/9 weighting, interests are given a 3/9 weighting, and opinions are given a 4/9 weighting. Other weighting ratios can also be employed. The following equation represents this mathematically:

Compatibility(U₁,Uₙ)= 2/9(CompareFacts(U₁,Uₙ))+ 3/9(CompareInterests(U₁,Uₙ))+ 4/9(CompareOpinions(U₁,Uₙ)) Equation 2:

The resulting compatibility factor is calculated for the requesting user (U₁) with respect to a candidate user (Uₙ) only. For example, the candidate user may be a 0.30 (30%) compatibility match for the requesting user. Because there is a perspective component in the determination of importance, participation, and compatibility factors, a corresponding compatibility of the candidate user with respect to the requesting user cannot be assumed. The following table is useful in understanding the comparison algorithm more fully. In order to accurately predict similarity on the formulas, the following three factors are employed in the comparison.

TABLE 6

| | |
|---|---|
| Commonality | Indicates the occurrence of common items in two given |
| Factor | lists of items or, if comparing individual items within |
| | the list, the commonality factor is binary, either true |
| | or false (1 or 0). The commonality factor is the most |
| | basic component to performing a comparison. It is stated |
| | as a directly proportional relationship between the |
| | number of matches and the number of items (i.e. the |
| | number of matches ÷ the number of items). |
| Importance | Indicates a level of importance of an item to a given |
| Factor | user. Importance is calculated with consideration to the |
| | number of interactions or mentions a user has with |
| | related items (related by topic or by interest). This |
| | factor is significant because commonality of an item with |
| | high Importance is more relevant to compatibility than |
| | items with less importance. |
| Participation | Represents a given user's level of participation in |
| Factor | inputting items. This factor is significant because it |
| | avoids the scenario where the user has provided only one |
| | item which matches singular input of other users. |
| | Otherwise, there might be numerous matches reporting |
| | 100% comparison, which could in turn report 100% |
| | compatibility, and that would be misleading and cause |
| | distrust in the system. This factor also improves |
| | confidence in the system because it adds weighting to |
| | calculations where the user has input more information |
| | about themselves. |

Note that since every user has unique interactions with each of their lists (facts, attributes, and opinions), each comparison algorithm is unique, but employ the same factors in particular fashion. For example, facts are limited to a few attributes that are specifically requested by the system for each user. Interests are categorized by subject and can have unlimited numbers of attributes. Opinions are broad and cover numerous aspects of many topics.

Comparison of Facts—

With respect to the comparison of facts, the matching facts simply equals the number of facts in common between the requesting user and a given candidate user. The requested facts equals the number of attribute types that are considered to be facts by the system (some attributes are not facts). Thus the following equations are pertinent to the comparison of facts.

CompareFacts(U₁,Uₙ)=MatchingFacts(U₁,Uₙ)/RequestedFacts Equation 3:
Note: GivenFacts is not represented in the CompareFacts( ) function. It is assumed in the individual commonality and participation factors but when combined, cancel each other to produce the simplified representation above.

Commonality Factor=MatchingFacts(U₁,Uₙ)/GivenFacts(U₁). Equation 4:

Importance Factor=1;since all facts have equal importance. Equation 5:

Participation Factor=GivenFacts(U₁)/RequestedFacts. Equation 6:

Comparison of Interests—

With respect to the comparison of interests, the interactions contemplated are the number of interactions and mentions of a given interest subject (Iᵢ) for a given user (Uₙ). The participation contemplated is the total number of interactions for all interest subjects (and related topics) for a given user. And, the importance contemplated is the ratio of interactions to participation, where T is the number of interests provided by the requesting user. The comparison of interest is therefore:

$$CompareInterests ( {U}_{1} , {U}_{n} ) = {\sum }_{i = 1}^{j} \frac{1 - \vert \frac{Interaction s ( {I}_{i} , {U}_{n} )}{Participation ( {U}_{n} )} - \frac{Interactions ( {I}_{i} , {U}_{1} )}{Participation ( {U}_{1} )} \vert}{j} \qquad Equation 7$$

Where:

Commonality Factor=1−|Importance(Iᵢ,Uₙ)−Importance(Iᵢ,U₁)| Equation 8:

Importance Factor=Interactionsₙ/Participation₁ Equation 9:

Participation Factor=Participationₙ−Participation₁ Equation 10:

Comparison of Opinions—

With respect to the comparison of opinions, the interactions are the number of interactions and mentions of the given Topic (T₁) for a given User (Uₙ). The participation is the total number of interactions for all interests (and related topics) for a given User (Uₙ). The importance is the ratio of interactions to participations, where ‘j’ is the number of interest subjects provided by the requesting user (U₁). The comparison of interest is therefore:

$$CompareInterests ( {U}_{1} , {U}_{n} ) = {{\sum }_{i = 1}}^{j} ( \frac{Interactions ( {T}_{i} , {U}_{1} )}{Participation ( {U}_{1} )} ) * ( \frac{Agrees ( {T}_{i} , {U}_{1} , {U}_{n} ) - Disagrees ( {T}_{i} , {U}_{1} , {U}_{n} )}{Agrees ( {T}_{i} , {U}_{1} , {U}_{n} ) + Disagrees ( {T}_{i} , {U}_{1} , {U}_{n} )} ) * ( 1 - \frac{1}{1 + Agrees ( {T}_{i} , {U}_{1} , {U}_{n} ) + Disagrees ( {T}_{i} , {U}_{1} , {U}_{n} )} ) \qquad Equation 11$$

Where:

Commonality Factor=(Agrees−Disagrees)/(Agrees+Disagrees) Equation 12:

Importance Factor=Interactions/Participation Equation 13:

Participation Factor=1−(1/(1+Agrees+Disagrees)) Equation 14:

Also note that, with respect to the comparison of opinions, the commonality factor described in the foregoing Equation 11 can provide a negative result indicating a level of disagreement, or incompatibility. Also note that because the foregoing calculations can become rather complex, such as by comparing every user with a given requesting user, the demands on system processor capacity can be large. In order to mitigate this effect, a pre-filter can be applied to the user selection process before the calculating and sorting the compatibility factors. For instance, the user may be required to specify a geographic limitation when searching for desirable results. Other limiting criteria may also be employed.

With respect to inferences drawn on user responses, words fused or both topics and interests exist in both the dictionary database and the thesaurus database. It is necessary for the system to utilize these to properly assign topics to questions. When a user inputs a question, all of the words used are compared to the thesaurus and the list of topics to find the closest matching topic. When a user inputs an interest, if it has a related word that is a topic, then an affinity for that topic is inferred and the system will offer the user questions categorized in that topic. When a user interacts with a topic with synonymous interests, then an affinity for those interests can be inferred. When a user uses a word in a question or response describing an interest or topic, an affinity for the matching interest or topic can be inferred. The following examples are instructive on this point:
1) User asks a question “Do you think the umpire made the right call at home in that Rangers game last night?” The use of the words “umpire”, “home”, “Rangers”, “game” can be used to infer the question belongs in the topic of “Baseball”. Baseball, the interest is inferred (treated as one interaction in comparison algorithm)
2) if a user inputs an interest of “Homeschool”, the system will offer questions asked on the topic of “Home Schooling” for the user to answer.
3) If a user answers a question on the topic of marriage, but mentions a Van Halen song in the response, an interest in Van Halen can be inferred (in algorithms, treated as one interaction with the interest “Van Halen” and one interaction with the topic “Marriage” and 1 interaction with the topic of “80's Rock”).

With respect to the use of words in the dictionary database, they can optionally have a connotation noted as negative or positive, as demonstrated above with the words “Love”, “Hate”, “Despise”, “ [symbol] ”. Certain language patterns can be used to identify which word a word with connotation acts on. For instance, in the English language, verbs typically act on the following noun as do adjectives. However, in the Spanish language, verbs act on following nouns and adjectives act on preceding nouns. Using the dictionary's language property, connotative words can be used to judge an emotion toward a target word. The following examples are instructive on this point:
1) User A answers the Question “Do you think the United States should go to war with North Korea if they refuse to stop pursuing nuclear weapons?” with a short response of “Yes” and a comment of “I hate the DPRK.”
2) The word “hate” has a negative connotation in the dictionary and the noun following “hate” in user A's response is “DPRK”, which is synonymous with “North Korea”, therefore it is understood that user A has a negative view of North Korea.
3) If user B answers the same question, it is easy to determine the agreement/disagreement on the topic for the purposes of the opinion comparison algorithm.
4) If user B does not answer the same question, but a similar one, such as “How much should the UN increase sanctions against the DPRK after the recent nuclear tests?” with a short response of “Heavily” and a comment of “North Korea is a bad situation all around and something must be done.”
5) The words “war” and “sanctions” could both be marked as a negative connotation in the dictionary and therefore, the two questions would be considered similar because they both contain a negative connotative word prior to a word synonymous with “North Korea”. Since the two questions are evaluated as similar, if the short response to each were “Yes”, this could be evaluated as one agree (for purposes of comparison algorithm). However, since the two short responses cannot be matched in any way, the comments can be analyzed to determine user B also has a negative view on North Korea and this can be evaluated as one Agree. If both the short response and the comments can be successfully evaluated as agree or disagree, the total agree/disagree would only be one.

With respect to the calculation processes, they are calculated in reference to the requesting user. If user A requested to be matched, the system would see user A responded to question #1. If user B also responded to question #1, a value of plus one is calculated toward the agree/disagree values for the topic of question #1 and then the next question answered by user A on that topic is considered. If user B did not respond to question #1, the system attempts to find a similar question based on the topic and words in the question. When question #2 is found to be similar, then the system attempts to match short responses and plus one the agree/disagree calculation. If the system still cannot resolve the agree/disagree, it compares the comments. If the system still cannot resolve the agree/disagree or a similar question was not found, then no value is added to the agree/disagree for question #1 and the system looks at the next question user A responded to. However, an inability to match questions to determine agree/disagree lowers the participation factor for the opinion comparison algorithm.

Thus, the present invention has been described herein with reference to particular embodiments for particular applications. Those having ordinary skill in the art and access to the present teachings will recognize additional modifications, applications and embodiments within the scope thereof. It is therefore intended by the appended claims to cover any and all such applications, modifications and embodiments within the scope of the present invention.

What is claimed is:

1. A method of determining relationship compatibility amongst plural users, which operates within a network interconnecting a processor, a database, and plural network terminals, the method comprising the steps of:
establishing user accounts in the database for plural users;
inputting questions into the database through the plural network terminals by the plural users;
classifying the questions according to plural topics;
soliciting responses to the questions, and storing the responses in the database;
determining, by the processor, opinions on the topics held by the plural users, either positive or negative, and storing the opinions on topics in the database, respectively, for the plural users;
requesting relationship recommendations through a first network terminal by a first user;
determining, by the processor, relationship compatibility factors for plural candidate users by sequentially correlating opinions of the plural candidate users with the opinions of the first user, and
recommending a subset of the plural candidate users for a relationship connection with the first user according to the relationship compatibility factors.

2. The method of claim 1, and wherein:
the user accounts include facts about corresponding users that are entered by the corresponding users, and
the user accounts include interests about the corresponding users that are entered by the corresponding users.

3. The method of claim 2, and wherein:
said establishing accounts step further comprises specifying plural subjects of interest from a predetermined list of interest subjects for said plural users.

4. The method of claim 1, and wherein:
said inputting questions step further comprises specifying selection criteria for a target audience within said plural users for whom a present question is directed.

5. The method of claim 1, and wherein:
said inputting questions step further includes selecting a question format from amongst a poll format, a short answer format, and a free-form text entry format.

6. The method of claim 1, wherein said classifying questions by topics step further comprises:
comparing the words in a given question with a predetermined list of question topic words, thereby identifying a specific topic for the given question.

7. The method of claim 6, and wherein:
said predetermined list of topic words is arranged in a hierarchal structure that defines a taxonomy of topics.

8. The method of claim 6, wherein said classifying questions by topics step further comprises the step of:
comparing words in the given question with a dictionary or thesaurus to identify a closest matching word in the predetermined list of question topic words.

9. The method of claim 1, and wherein said soliciting responses step further comprises:
presenting a given question to a subset of said plural users who have a preexisting relationship with a first user who asked the given question.

10. The method of claim 1, and wherein said soliciting responses step further comprises:
presenting a subset of recently asked questions from said plural questions to said plural users.

11. The method of claim 2, and wherein said soliciting responses step further comprises:
presenting a given question to a given user because the topic of the given question correlates to the given user's account information, which may be interests, topics, or opinions.

12. The method of claim 1, and wherein said soliciting responses step further comprises:
presenting a given question to a subset of the plural users based on the frequency with which the given question has been previously responded to.

13. The method of claim 1, and wherein said determining opinions on topics step further includes:
examining the words in the responses for positive and negative connotations.

14. The method of claim 1, and wherein said determining opinions on topics step further includes:
conducting a dictionary look-up of words in the response for predetermined positive and negative connotations, and
translating the connotations into the positive and negative opinions.

15. The method of claim 1, and wherein said determining opinions on topics step further includes:
making an inference determination on the words in the responses based on predetermined connotations of the words in the responses.

16. The method of claim 2, and wherein said determining opinions on topics step further includes:
examining a given user's account data for interest in a subject, and thereby inferring an interest in a corresponding topic.

17. The method of claim 1, and wherein said requesting relationship recommendations step further comprises:
specifying selection criteria to define a subset of the plural users eligible for a relationship recommendation.

18. The method of claim 17, and wherein said selection criteria are selected from user gender, user interests, user facts, and user opinions.

19. The method of claim 1, and wherein said determining relationship compatibility factors step further comprises:
determining that a given user and a candidate user have both responded to a common question in the same way.

20. The method of claim 1, and wherein said determining relationship compatibility factors step further comprises:
determining that a given user and a candidate user have both affirmed, or disaffirmed, the response of another user in the same way.

21. The method of claim 2, and wherein said determining relationship compatibility factors step further comprises:
comparing the facts and interests of the first user and the candidate users.

22. The method of claim 21, and wherein said determining relationship compatibility factors step further comprises:
individually weighting the comparison of facts, interests, and opinions in calculating the relationship compatibility factor.

23. The method of claim 2, and wherein said determining relationship compatibility factors step further comprises:
assessing the occurrence of common items in the user account database of the first user and each candidate user, thereby defining a commonality factor.

24. The method of claim 2, and wherein said determining relationship compatibility factors step further comprises:
assessing the number of interactions on a given topic for the first user and each candidate user, thereby defining an importance factor.

25. A system for determining relationship compatibility amongst plural users, which operates within a network, the system comprising:
a processor;
a database;
plural network terminals;
wherein said processor is operable to establish accounts in the database for the plural users;
said processor is operable to receive questions input through said plural network terminals by the plural users, and operable to store said questions in said database;
a means for classifying said questions according to plural topics;
said processor is operable, through said plural network terminals, to solicit responses to said questions, and to store said responses in said database;
said processor is operable to determine opinions on the topics held by the plural users, either positive or negative, and store said opinions in said database, respectively, for the plural users;
said processor is operable to receive a requests for relationship recommendations through a first network terminal by a first user, and determine relationship compatibility factors for plural candidate users by sequentially correlating opinions of said plural candidate users with opinions of said first user, and
said processor is operable to recommend a subset of said plural candidate users for a relationship connection with said first user according to said relationship compatibility factors.

26. The system of claim 25, and wherein:
said user accounts include facts about said plural users that are entered by corresponding users, and
said user accounts include interests about said plural users that are entered by said corresponding users.

27. The system of claim 26, and wherein:
said plural network terminals enable said plural users to specify plural subjects of interest from a predetermined list of interest subjects, which are stored in said database.

28. The system of claim 25, and wherein:
said processor is further operable to receive selection criteria together with said questions, and wherein said selection criteria specifies a target audience within the plural uses for whom a present question is directed.

29. The system of claim 25, and wherein:
said processor is operable to receive questions having a poll format, a short answer format, or a free-form text entry format from said plural network terminals.

30. The system of claim 25, and wherein:
said processor is further operable to classify questions by comparing the words in a given question with a predetermined list of question topic words, thereby identifying a specific topic for the given question.

31. The system of claim 30, and wherein:
said predetermined list of topic words is arranged in a hierarchal structure that defines a taxonomy of topics.

32. The system of claim 30, and wherein:
said processor is further operable to compare words in said given question with a dictionary or thesaurus to identify a closest matching word in said predetermined list of question topic words.

33. The system of claim 25, and wherein:
said processor is further operable to present a given question from a first user to solicit a response from a subset of said plural users who have a preexisting relationship with said first user.

34. The system of claim 25, and wherein:
said processor is further operable to present a subset of recently asked questions from said plural questions to said plural users so as to solicited responses therefrom.

35. The system of claim 26, and wherein:
said processor is further operable to present a given question to solicit a response from a given user because the topic of said given question correlates to said given user's account information, which may be facts interests, or opinions.

36. The system of claim 25, and wherein:
said processor is further operable to present a given question to solicit a response from to a subset of the plural users based on the frequency with which said given question has been previously responded to.

37. The system of claim 25, and wherein:
said processor is further operable to exam the words in said responses for positive and negative connotations, so as to determine opinions on topics for corresponding users.

38. The system of claim 25, and wherein:
said processor is further operable to conduct a dictionary look-up of words in said responses to identify predetermined positive and negative connotations, and operable to translate the connotations into the positive and negative opinions on said topic.

39. The system of claim 25, and wherein:
said processor is further operable to make an inference determination on the words in the responses based on predetermined connotations of said words, so as to determine opinions on said topics.

40. The system of claim 26, and wherein:
said processor is further operable to examine a given user's account data for interest in a topic, and thereby infer a positive opinion on said topic.

41. The system of claim 25, and wherein:
said processor is operable to receive, from said plural network terminals, specific selection criteria to define a subset of the plural users eligible for a relationship recommendation.

42. The method of claim 41, and wherein said selection criteria are selected from user gender, user interests, user facts, and user opinions.

43. The system of claim 25, and wherein:
said processor is further operable to determine that a given user and a candidate user have both responded to a common question in the same way, so as to determine a relationship compatibility factor therebetween.

44. The system of claim 25, and wherein:
said processor is further operable to determine that a given user and a candidate user have both affirmed, or disaffirmed, a response of another user in the same way, so as to determine relationship compatibility factor therebetween.

45. The system of claim 26, and wherein:
said processor is further operable to compare the facts and interests of a first user and a candidate users, so as to determine a relationship compatibility factor therebetween.

46. The system of claim 45, and wherein:
said processor is further operable to individually weight the comparison of facts, interests, and opinions in calculating said relationship compatibility factor.

47. The system of claim 26, and wherein:
said processor is further operable to assess the occurrence of common items in said user account database of a first user and each candidate user, thereby defining a commonality factor, which is applied in determining relationship compatibility factors.

48. The method of claim 26, and wherein:
said processor is further operable to assess the number of interactions on a given topic for a first user and each candidate user, thereby defining an importance factor, which is applied in determining relationship compatibility factors.

49. The method of claim 26, and wherein:
said processor is further operable to assess the level of participation in inputting responses on a given topic for a first user and each candidate user, thereby defining an participation factor, which is applied in determining relationship compatibility factors.
